(19) United States
(12) Patent Application Publication
(10) Pub. No.: US 2010/0229204 A1
(43) Pub. Date: Sep. 9, 2010

(54) METHOD AND APPARATUS FOR BROADCASTING AND RECEIVING EVENT DATA

(75) Inventors: Gilein De Nijs, Eindhoven (NL); Steven Broeils Luitjens, Eindhoven (NL); Jozef Pieter Van Gassel, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/377,710

(22) PCT Filed: Aug. 16, 2007
(86) PCT No.: PCT/IB07/53267

§ 371 Date: Feb. 17, 2009

(30) Foreign Application Priority Data
Aug. 18, 2006 (EP) 06119153.2

(51) Int. Cl. H04N 7/16

(52) U.S. Cl. 725/62

(57) ABSTRACT

Broadcast data is transmitted in first time slices. Event data is transmitted in second time slices, wherein a predetermined number n−1 of consecutive second time slices is redundant. Therefore a receiver receiving such a broadcast need only receive one of n slices of event data. Therefore when the receiver is in standby mode, it need only be activated to receive 1 in n of second time slices to receive event data. Therefore the receiver is deactivated for a longer period, thus saving power consumption.

### FIELD OF THE INVENTION

The present invention relates to method and apparatus for broadcasting and receiving event data. In particular, but not exclusively, it relates to method and apparatus for broadcasting and receiving event data for reducing power consumption in portable handheld electronic devices such as mobile televisions or the like.

### BACKGROUND OF THE INVENTION

Television on mobile telephones and mobile television on dedicated devices is expected to become widespread technology in the near future. Technology demonstrators have already been introduced at various exhibitions and the first commercially available products have been launched this year. Telecommunication and broadcasting companies are planning or are already conducting try-outs.

The broadcasting standard used for mobile television is known as DVB-H (Digital Video Broadcast Handheld). The physical layer is almost identical to that of DVB-T (Digital Video Broadcast Terrestrial). The link layer however introduces (among others) mandatory time-slicing in order to reduce the average power consumption of the receiving terminal and enable smooth and seamless frequency handover. Time-slicing consists of sending data in bursts using a significantly higher instantaneous bit rate compared to the bit rate required if the data were transmitted using traditional streaming mechanisms. Between bursts the receiver of the mobile terminal can be switched off and the stream can be played from a buffer. In this way multiple services can share a frequency, and a mobile device which is tuned to one specific service, for example, services S1, S2 or S3 as illustrated in FIG. 1a, can save a significant amount of power.

A standard DVB-H transmission comprises an MPEG-2 transport stream, with a number of MPEG2 programs, each with its own program identifiers, PID1, PID2, PID3 illustrated in FIG. 1a. As DVB-H is fully IP based, the only content of such an MPEG2 program is the MPE section, where IP packets are encapsulated. Each DVB-H service (either audio/video or eventing) is encapsulated in its own program with its own PID. The separate MPEG2 programs are multiplexed in the MPEG2 transport stream in a time slicing way. The applicable standards give lots of freedom on the constellation of this time slicing, but typically it is done round robin, with a fixed cycle period, t₁.

Current technologies for IP connectivity on a mobile device based on 3G (UMTS) are available. This can be used as an interactive back channel for a DVB-H broadcast, e.g., for voting during a live show or for authentication or payment purposes. Such a non-broadcast channel can also be used for video on-demand streaming. This does have the disadvantages including the limited bandwidth in a UMTS cell as well as the higher cost for the user. However, streaming video over 3G is a good solution for less popular content or as backup if the DVB-H reception fails.

An eventing mechanism can be used to inform the user or the mobile device about certain situations or situation changes, either related to a specific service or of a more general nature. Examples of service related events include the start of a certain TV show, the start of a specific item in a broadcast (e.g., the summary of a specific soccer match), or a specific event in a live broadcast (e.g., an important moment in a sporting match: ‘swimmers are approaching finish line’). More general events include news items or stock tickers. Events can also be used to inform the mobile device itself to perform a certain action, e.g., if the ESG (Electronic Service Guide) is updated, the device can receive an event about this and in turn get the updated version. This way, the devices gets updates as they are deployed while not having to receive the ESG channel continuously.

The delivery of events can be either embedded in a service channel of a TV broadcast as shown in FIG. 1b or in a separate eventing service as shown in FIGS. 1c and d, respectively. Events E1 and E3 may be embedded within the audio/video services S1 and S3, respectively as shown in FIG. 1b. Alternatively events may be broadcast separately as shown in FIG. 1c. In this example, events E1, E2 are broadcast separately having their own program identifier PID4. FIG. 1d illustrates events broadcast separately having different cycle times, for example audio/video broadcast data has a cycle time t₁, and the eventing cycle is longer, t₂.

Either way, some events should be received independent of the channel the user is tuned to; so separate eventing services are preferred.

Many systems have been implemented to allow reception of event data or service data. For example EP1549069 discloses a DVB-H receiver in which service data is transmitted in bursts on a transmission channel and background information from other services is obtained and stored between bursts (in the off-time interval). The transmission and update of the background information depends on the current battery status. However, maintenance of such a background information service requires additional power.

Some events are of such a nature that a user wants ideally to always receive them, independent of the state of the mobile device. Such events include notifications of important moments in sports matches or notification of the start of a TV broadcast. Even if the device is in a standby mode, the user might want to be notified of situations like this, or if the user is away from the device, the device itself might decide to act on these events and start a recording (if this is according to the user's profile). Another example is a notification of significant changes in the stock market when received in a stock ticker.

If events are broadcast with the normal mechanism for DVB-H file delivery (FLUTE) and with the normal time-slicing parameters, the DVB-H receiving part of the normal device has to wake up every time-slicing cycle (varying from one to ten seconds) to possibly receive new events. For events that the user wants to receive independent of the state of the device this has to take place even if the device is in a standby state. This will drain the battery of the device fairly quickly.

### SUMMARY OF THE INVENTION

Therefore, it would be desirable to provide a system which receives up-to-date event data which reduces power consumption.

This is achieved according to a first aspect of the present invention by a method for broadcasting data and event data, the method comprising the steps of: broadcasting data in first time slices; broadcasting event data in second time slices, wherein a predetermined number, n−1, of consecutive second time slices is redundant.

This is also achieved according to a second aspect of the present invention by a method for receiving first data, the first data being transmitted in first time slices and receiving second data, the second data being transmitted in second time slices, the method comprising the steps of: receiving the first data within each of said first time slices; receiving the second data within one of n second time slices; wherein n is an integer greater than 1.

This is also achieved according to a further aspect of the present invention by apparatus for broadcasting data and event data, the apparatus comprising: a transmitter for broadcasting data in first time slices; and a transmitter for broadcasting event data in second time slices, wherein a predetermined number n−1 of consecutive second time slices is redundant.

This is also achieved according to a further aspect of the present invention by a receiver for receiving first data, the first data being transmitted in first time slices and second data, the second data being transmitted in second time slices, the receiver comprising: means for receiving the first data within each of said first time slices; means for receiving the second data within one of n second time slices; wherein n is an integer greater than 1.

Therefore, event data is broadcast in a so-called ‘superslices’. These are short time-slices that are broadcast in the normal time-slicing cycle, only consecutive slices contain redundancy in such a way that only one slice every n slices needs to be received by a mobile device to stay up-to-date on the events.

Normally, if a normal time-slicing cycle (first time interval) is 3 seconds, and if the receiver receives 1 in every 20 slices, i.e. n=20 due to the redundancy, the receiver turns on 20 times less frequently to receive event data during standby mode. Therefore the receiver remains switched off for longer periods. Given the low bandwidth nature of the events, the actual transmission of the events is not a big factor in the power consumption, especially if events occur infrequently so most of the time the receiver turns on just to check for the occurrence of events without receiving any actual data. In this numerical example the power of the receiver is reduced to 1/20 for staying up-to-date on events.

The priority of the abovementioned events is in most cases not real-time, that is, receiving the event 30 seconds or a minute later is no problem, especially if the receiving device is in a standby mode. This combined with the fact that events are mostly not very frequent and naturally low bandwidth, allows the time-slicing scheme for broadcasting the event data to be modified in order to save power.

A top-of-the-line low power DVB-H receiver consumes on average about 45 mW. With the method of the present invention, the receiver can stay up-to-date on events while consuming only about 2 mW. This is comparable with a low power WiFi module in standby. A GSM module in standby consumes around 12 mW.

The event data may be repetitively broadcast in the second time slices k times, wherein k is an integer such that k≦n.

If the number of events rises above a certain threshold, the overhead of repeating every event might become too large, bandwidth wise. In the preferred embodiment, events can be classified by importance and only important events are repeated every slice for n times. Less important events are repeated k times (thus every n/k slices), and the least important events repeated only once (after n slices). All unimportant events can be bundled in the same slice, so a cycle is created with every n slices a slice with all pending events, and the slices in between only having more important events. The constellation of this cycle may be communicated to the receiver, either by special ESG fields or in the eventing service itself.

Preferably, each of a plurality of consecutive slices of said second data transmitted over a plurality of consecutive slices for a period is received upon detection of a trigger. The trigger may comprise detection of power on of a device.

Therefore, to make sure the receiver still gets all the events, even when the device is just switched on and the first event slice is one with only important events, each slice may contain information that tells the receiver if there are any pending events that are not in that particular slice. Also, each slice communicates in how many slices the slice with all events is transmitted. This way, the receiver is turned on and can quickly find the eventing service and receive important events, and from that moment can synchronize with the slice containing all pending events.

### BRIEF DESCRIPTION OF DRAWINGS

For a more complete understanding of the present invention, reference is now made to the following description taken in conjunction with the accompanying drawings in which:

FIG. 1a is a graphical representation of a normal DVB-H broadcast without events;

FIG. 1b is a graphical representation of a normal DVB-H broadcast with embedded events;

FIG. 1c is a graphical representation of a normal DVB-H broadcast with a separate eventing service;

FIG. 1d is a graphical representation of an example of normal DVB-H broadcast with a separate eventing service having different cycle times;

FIG. 1e is a graphical representation of a DVB-H broadcast according to an embodiment of the present invention; and

FIG. 2 is a simple schematic diagram of a DVB-H receiver device according to the embodiment of the present invention.

### DETAILED DESCRIPTION OF EMBODIMENTS OF THE INVENTION

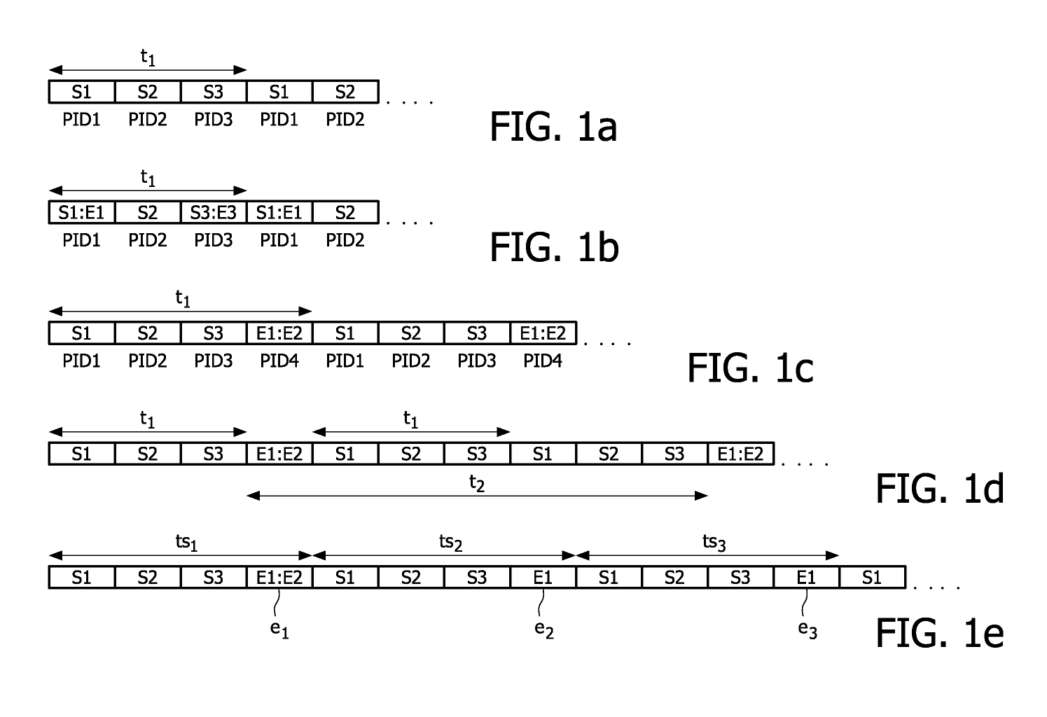

As shown in FIG. 1e, the DVB-H receiver of an embodiment of the present invention receives audio/video data broadcast in bursts over a time intervals ts₁, ts₂, ts₃. In between bursts, the receiver is switched off and thus saving power consumption.

Events are transmitted in time slices either embedded or in separate time slices e₁ . . . eₙ as shown in FIG 1e. Consecutive event slices e₁, e₂, . . . eₙ₋₁, eₙ contain redundancy such that slice e₂ . . . eₙ are redundant. The DVB-H receiver according to the embodiment of the present invention receives 1 of n^{th} slices and as result the receiver remains switched off between receipt of the event slices, namely for the time period ts₂+ts₃ . . . tsₙ.

As illustrated in FIG. 1e, the superslice of the time slicing mechanism of the preferred embodiment of the present invention, one of the event slices e₁ contains all events which is included once every n cycles, the remaining cycles e₂ . . . eₙ contain only important events. For the purposes of redundancy, the remaining cycles e₂ . . . eₙ contain duplication of the most important events. However, redundant slices without events may be created, that only indicate when the superslice with all events will be broadcast. The frequency of these empty slices is a variable, depending on the number and importance of pending events.

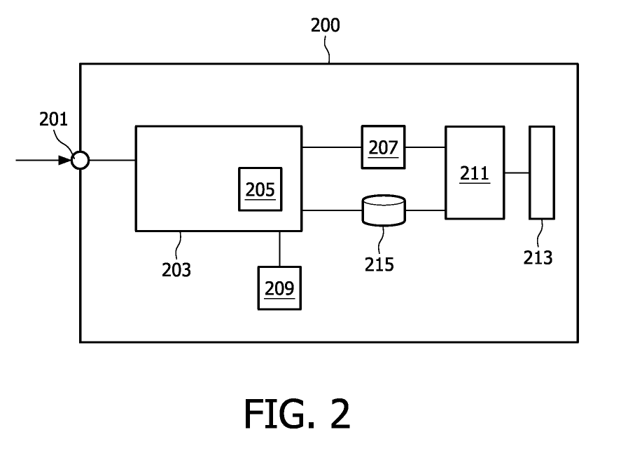

A DVB-H receiver device according to the embodiment of the present invention is shown in FIG. 2. The receiver device 200 is a portable handheld device which is battery operated. The receiver device 200 comprises an input terminal 201 connected to a demodulator 203. The demodulator 203 comprises a time slicing controller 205. The demodulator 203 is connected to the input of a buffer 207, an event memory 215 and a power controller 209. The output of the buffer 207 and event memory 215 is connected to a display controller 211. The display controller 211 is connected to a display 213 of the DVB-H receiver device 200.

Operation of the DVB-H receiver device 200 will now be described in more detail with reference to FIGS. 1e and 2. The DVB-H receiver device 200 operates in two modes, an operating mode in which the demodulator 203 of the receiver device 200 is activated and receives input broadcast data and event data in time slices as illustrated in FIG. 1e via the input terminal 201. The demodulator 203 demodulates the content a received burst. In between bursts, the power controller 209 switches power off to the demodulator to reduce power consumption of the receiver device 200. The high bit rate demodulated broadcast data is buffered in the buffer 207 awaiting display on the display 213 via display controller 211. The demodulated event data is stored in an event memory 215. Depending on the type of event data, the event data may update existing stored event data, replace existing stored event data, stored as new event data or temporarily stored in the event memory 215. The event data is then retrieved upon request by the user, at times designated by the user or upon occurrence of the event and shown on the display 213.

The other mode of operation of the receiver device 200 is a standby mode in which the receiver device is not fully activated. The demodulator 203 of the receiver device 200 is activated to receive only event data in slices as illustrated in FIG. 1e via the input terminal 201. Therefore, according to the embodiment of the present invention, the receiver device 200 receives event data in a slice e₁. Since the remaining e₂ to eₙ slices are redundant, the demodulator 203 is switched off after the first slice e₁ of event data is received and remains switched off during transmission of the redundant slices e₂ to eₙ. Therefore, the demodulator 203 remains switch off for a longer period ts₁+ts₂ . . . +tsₙ, saving on the power consumption of the device.

Each slice of broadcast data and event data contains information indicating the size of the time-slicing cycle. The time-slice controller 205 and power control 209 are then able to turn the demodulator 203 on just before receipt of the next slice. Therefore correct operation of the time-slicing mechanism assumes that the receiver device 200 receives every slice or slice. Consequently, it is not possible to determine when exactly a slice will be transmitted when the receiver device 200 didn't receive the previous one.

When the receiver device 200 is in standby mode and as result is receiving 1 in n slices of event data. The receiver device 200 receives slice eₙ₊₁ but does not receive the previous slice eₙ. Therefore the receiver device 200 is not able to predict the arrival of the next slice eₙ₊₁, from information provided in the last received slice e₁ to be able to turn the demodulator on ready to receive the next event data slice. The time intervals between the slices are kept fairly constant, and therefore the time of broadcast of the event slice eₙ₊₁ somewhere in the future can be determined with enough accuracy. The constant cycle time can be easily determined by adding the length of the current time interval to the relative time of the next time interval; this multiplied by the number of time intervals the receiver device 200 wants to skip (redundancy) gives a fairly precise indication of when that slice will be broadcast. Possible fluctuations in the cycle time are averaged out when a number of slices are skipped, and the receiver device 200 can switch on somewhat earlier to compensate for an error in this estimation. If a slice is missed due to these timing issues, the receiver device can just stay on until the next slice is received, which will only take as long as the normal cycle time (e.g., 3 seconds). This costs a little more power, but no information is lost.

The content of the actual event slices depends on the frequency of the events. The mechanism should be both efficient if very few events occur, as well as scalable to many events. In the case of a low event frequency, all events should be repeated in n slices, such that a receiver device which receives one slice every n transmitted slices still receives all events. This way, the device of the embodiment has a redundancy of a factor n, but given the low frequency and the low bandwidth of a single event, this is not problematical.

If the number of events rises above a certain threshold, the overhead of repeating every event might become too large, bandwidth wise. In this case, events can be classified by importance and only important events should be repeated every slice (slice) for n times. Less important events can be repeated k times (thus every n/k slices), and the least important events should be repeated only once (after n slices). All unimportant events can be bundled in the same slice, so a cycle is created with every n slices a slice with all pending events, and the slices in between only having more important events. The constellation of this cycle should be communicated to the receiver device 200, either by special ESG fields or in the eventing service itself.

To make sure the receiver device 200 still gets all the events, even when the device is just switched on and the first event slice is one with only important events, i.e. e₂ . . . eₙ each slice may contain information that tells the receiver device 200 if there are any pending events that are not in that particular slice. Also, each slice communicates in how many slices the slice with all events is transmitted, i.e. e₁. This way, the demodulator 203 of the receiver device 200 is turned on and can quickly find the eventing service and receive important events, and from that moment can synchronize with the slice containing all pending events.

A DVB-H receiver device 200 also receives PSI/SI tables to determine if the stream constellation is changing. Although these tables are transmitted quite frequently alongside the DVB-H time-slices, a receiver that is only tuned to a very low bandwidth eventing service might miss those tables. To avoid this, the head-end makes sure that these tables are at least transmitted at the time the event slice containing all events is transmitted, i.e. e₁. This way, also devices in standby that are only tuned to receive an eventing slice every n slices get the latest PSI/SI tables.

As an additional fail-safe mechanism, a sanity check, the receiver device 200 checks if the information that it receives is what it expects to receive, i.e., if it is indeed an eventing service that it's tuned to, and if the events make sense to the device. If this is not the case, the service constellation might have changed without the device noticing it and the receiver device 200 restarts the default bootstrapping procedure to find the eventing service again.

The methods described above enable, new, extremely low bandwidth and low power services, which might have a high added value. Mobile devices that are kept up-to-date of the current status (in the broadest sense of the word) are a feature that stimulates the use of DVB-H. Examples are a mobile device that gets informed of ESG changes (or changes for other elements in the FLUTE carousel) even in standby mode and subsequently receives the new ESG (or other FLUTE content), so that the user has access to the current ESG (or other FLUTE content) immediately when turning on the device instead of having to wait for the device to update, or users that receive alerts for important news items (or emergency warnings), even with the device in standby.

The methods can be applied in all DVB-H receiving devices which benefit by having lower power consumption. This includes mobile phones or portable media centers. Lower power consumption and thus a longer battery life is beneficial for the acceptance of DVB-H as mobile television standard

Although a preferred embodiment of the present invention has been illustrated in the accompanying drawings and described in the foregoing description, it will be understood that the invention is not limited to the embodiment disclosed but is capable of numerous modifications without departing from the scope of the invention as set out in the following claims.

1. A method for broadcasting data and event data, the method comprising the steps of:
broadcasting data in first time slices; and
broadcasting event data in second time slices, wherein a predetermined number n−1 of consecutive second time slices is redundant.

2. A method according to claim 1, wherein said event data is repetitively broadcast in said second time slices k times, wherein k is an integer such that k<n.

3. A method according to claim 2, wherein the value of k is dependent on the importance rank of said event data.

4. A method for receiving first data, said first data being transmitted in first time slices and receiving second data, said second data being transmitted in second time slices, the method comprising the steps of:
receiving said first data within each of said first time slices;
receiving said second data within one of n second time slices;
wherein n is an integer greater than 1.

5. A method according to claim 4, wherein the period of said second time slice is greater than the period of said first time slice.

6. A method according to claim 4, wherein all of said second data is transmitted in one of n second time slices and the step of receiving said second data comprises receiving said one time slice.

7. A method according to claim 6, wherein said first time slice is synchronized with transmission of PSI/SI tables.

8. A method according to claim 4, wherein each redundant time slice comprises event data ranked as important.

9. A method according to claim 4, wherein the method further comprises the steps of:
receiving each of a plurality of consecutive time slices of said second data transmitted over a plurality of consecutive time slices for a period upon detection of a trigger.

10. A method according to claim 9, wherein said period is greater than the period of said first time slice.

11. A method according to claim 9, wherein said trigger comprises detection of power on of a device.

12. A method according to claim 4, wherein said first data is digital broadcast data.

13. A method according to claim 4, wherein said second data comprises low bandwidth digital message data.

14. Apparatus for broadcasting data and event data, the apparatus comprising:
a transmitter for broadcasting data in first time slices; and
a transmitter for broadcasting event data in second time slices, wherein a predetermined number n−1 of consecutive second time slices is redundant.

15. A receiver for receiving first data, said first data being transmitted in first time slices, and second data, said second data being transmitted in second time slices, the receiver comprising:
means for receiving said first data within each of said first time slices;
means for receiving said second data within one of n second time slices;
wherein n is an integer greater than 1.

16. A receiver according to claim 15, wherein said first data is digital broadcast data.

17. A receiver according to claim 15, wherein said second data comprises low bandwidth digital message data.

18. A portable electronic device comprising a receiver according to claim 14.
